(19) United States
(12) Patent Application Publication
(10) Pub. No.: US 2004/0124611 A1
(43) Pub. Date: Jul. 1, 2004

(54) Baby carriage and baby's car seat

(76) Inventors: Michael Gong, West Winterslow (GB); Hung-Chung Hou, Ta Pao City (TW); Yung-Shuen Lin, Ta Pao City (TW)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/625,766

(22) Filed: Jul. 23, 2003

(30) Foreign Application Priority Data
Jul. 29, 2002 (TW) 091211649

(51) Int. Cl. B62B 1/00

(52) U.S. Cl. 280/642

(57) ABSTRACT

A baby carriage chassis can have in a baby's car seat mounted thereon. The chassis comprises a main frame and a pair of support frames pivotally connected to the main frame for angular movement. In a first position, the support frames are substantially coplanar with one another to provide support for a baby's back when used without a car seat. In a second position, the pair of support frames are extended into a V-shape to accommodate and support front and rear retaining portions on the car seat.

### FIELD

This invention relates to a chassis of a baby carriage that can serve as a stroller and also as a transporter for a baby's car seat,

### RELATED ART

Most traditional baby carriages can only serve as simple transportation equipment in which parents can push their babies around. Therefore, when a baby is to travel first by car and then in a stroller, the baby has to be moved from a baby's car seat to the stroller. Safety regulations require babies to be fastened placed in a baby's car seat using five-point seat belts. Even when babies are placed in strollers, they still have to be fastened with either 3-point or 5-point seat belts. However, when parents have to unbuckle the five-point seat belts on sleeping babies and then put them in baby carriages with the seat belts, babies can be easily awakened.

To solve the problems described above, a baby's car seat that can be connected to a stroller has been proposed, for example as described in U.S. Pat. Nos. 5,772,279 and 5,794,951, which each disclose the use of at least one additional coupling member for connecting the middle of each side a car seat to the joints on the sides of the baby carriage. However the center of gravity of the baby is not coincident with the center of the seat, resulting the imposition of an unbalance load. In addition, these arrangements suffer from the inconvenience that the or each coupling member have to be carried or stored separately when the baby's car seat not being transported.

### SUMMARY OF THE INVENTION

To overcome the problems described above, the primary objective of this invention is to provide a pair of support frames connecting to the framework, which can be extended into a V-shape to support the front and back positions of the baby's car seat for better and firm fastening effect.

Another objective of this invention is to provide a support frame pivotally connected to the seat shaft, which works as a pivot for a backrest in the absence of the baby's car seat.

Other objects of the invention can be comprehended from the detailed description provided below. This description is provided by way of example only. Changes and modifications will be understood by those skilled in the art. The detailed description and drawings are only for illustration purposes and do not limited the scope of the invention.

### BRIEF DESCRIPTION OF THE DRAWINGS

FIG. 1 is a perspective view of a chassis for a baby carriage in accordance with the invention, in a configuration to receive a baby's car seat which is located above the chassis;

FIG. 2 is a schematic view of a latch for securing the baby's car seat to the chassis;

FIG. 3 is a perspective view of the chassis shown in FIG. 1, in a configuration for use as a pushchair, with a seatback mounting shown on an enlarged scale;

FIG. 4 is a perspective view of the part of the chassis on which the car sear is supported;

FIG. 5 is a schematic view illustrating various positions of the backrest of the chassis shown in FIG. 1; and

FIG. 6 is a side view showing the baby's car seat mounted on the chassis.

### DETAILED DESCRIPTION OF THE PREFERRED EMBODIMENT

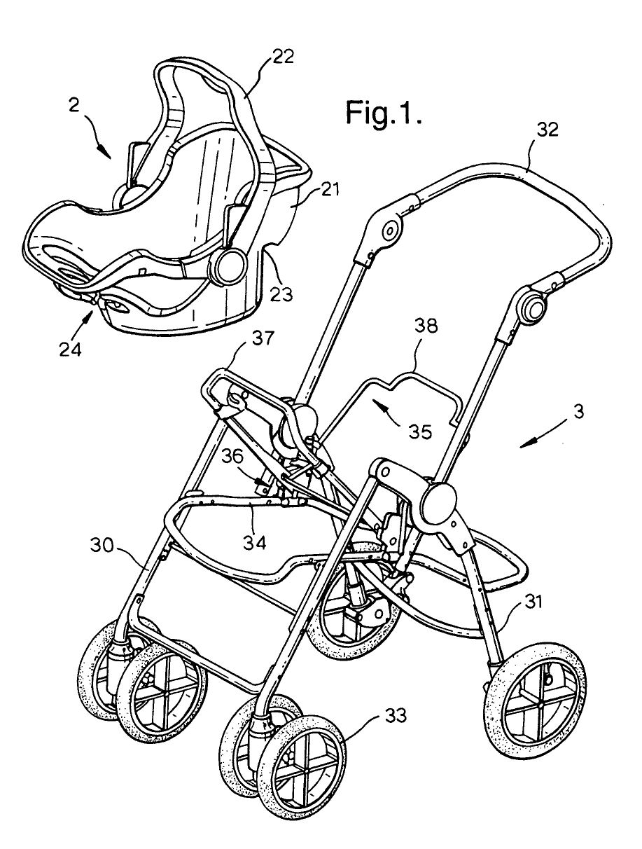

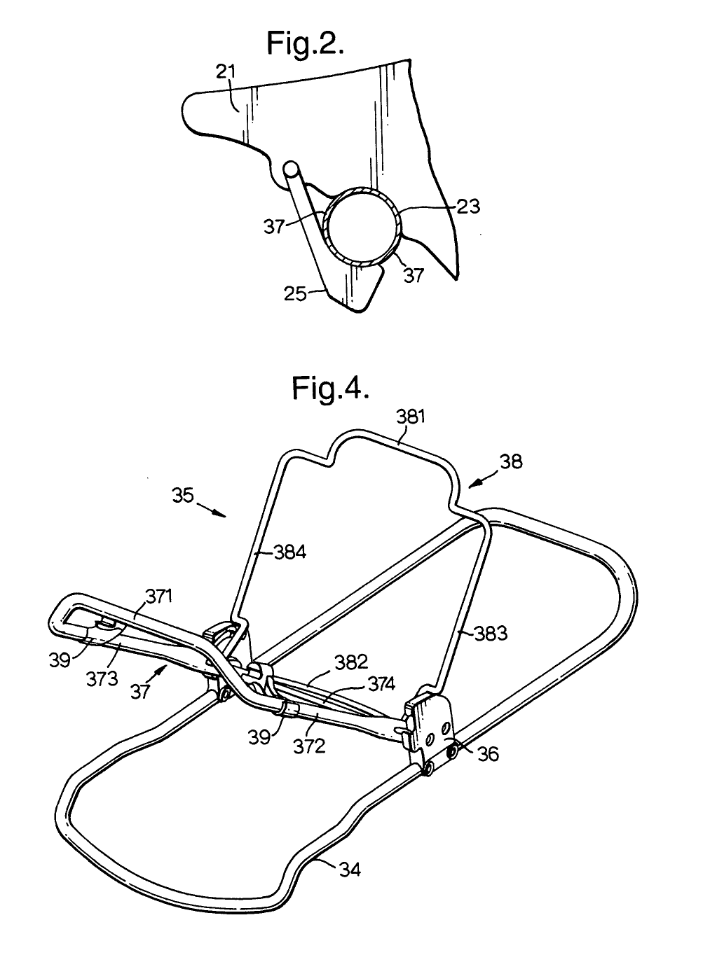

FIG. 1 shows a baby's car seat 2 having a one-piece main body 21, in which a baby can be placed, and a handle 22. The main body 21 is formed with a front retaining portion 23 and a rear retaining portion 24. A lever latch 25 is provided at the front retaining portion 23, as shown in FIG. 2.

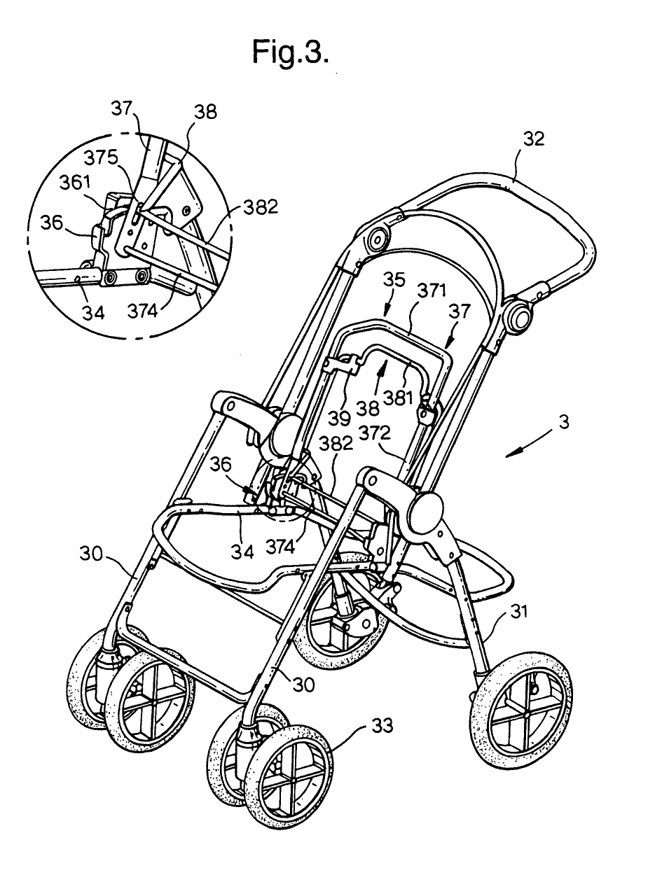

Referring also to FIG. 3, a chassis 3 of a baby carriage has a main frame comprising pivotally interconnected front and back legs 30, 31, a handle 32, a set of wheels 33 and a seat support member 34. A support assembly 35 and for a backrest are mounted on the seat support member 34 via two pivot mountings 36. Each pivot mounting 36 is fixed to the seat shaft 34 and has several detent notches 361 to provide a series of alternative positions for a backrest, as will be explained hereinafter.

As can be seen from FIG. 4, the support assembly 35 is pivotally mounted on the pivot mountings 36 and consists of an inverted U-shaped front support frame 37 and an inverted U-shaped back support frame 38.

The front support frame 37 comprises an upper horizontal rod 371 interconnecting two vertical rods 372 and 373 which have their lower ends connected to a pivot rod 374, the ends of which pivotally engage in respective pivot mountings 36. The upper horizontal rod 371 provides a support position for the front retaining portion 23 of the car seat 2. A long slot 375 (FIG. 1) is formed at an end of each of the vertical rods 372 and 373 adjacent to the mountings 36.

The back support frame 38, comprises an upper horizontal rod 381 and a lower horizontal rod 382 that interconnect two vertical rods side 383 and 384. The upper horizontal rod 381 provides a support position for the rear retaining portion 24 of the car seat 2 at the. The lower horizontal rod 382 passes through the slots 373 in the vertical rods 372 and 373 of the front support frame 37 so as to extend into the notches 361 on the pivot mountings 36, allowing the lower horizontal rod 382 of the back support frame 38 both to pivot about and to move along the slots 373.

Near the upper ends of the vertical rods 372, the front support frame 37 carries retaining catches 39 that can engage with the vertical rods 383 and 384 of the rear support frame 38 to hold the two support frames 37 and 38 in substantially coplanar relationship, as shown in FIG. 3.

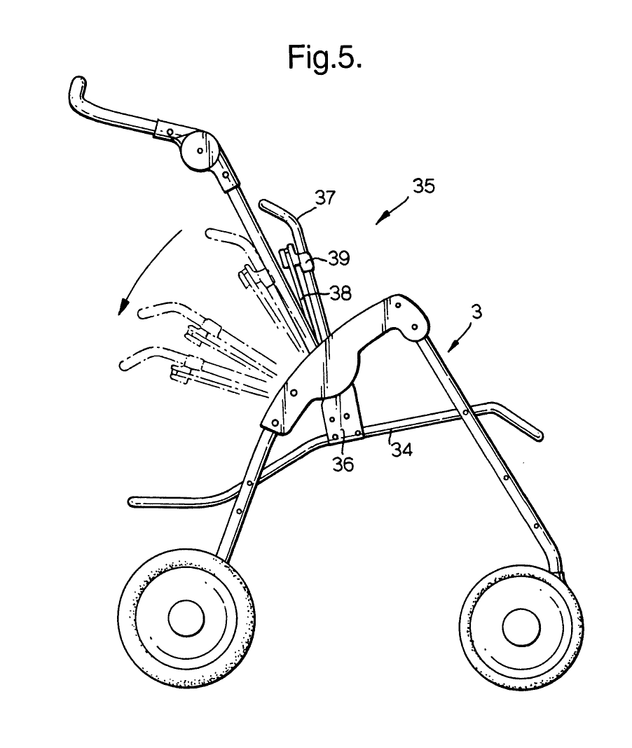

Turning to FIG. 5, when the chassis 3 is to be used as a pushchair or stroller, the two support frames 37 and 38 are latched together by the catches 39 so as to support a backrest. The seat of the pushchair is supported on the seat support member 34. The upper horizontal rods 371 and 381 can be squeezed together so as to disengage the ends of the lower horizontal rod 382 of the rear support frame 38 from the notches 361 on the pivot mountings 36 against the action of a biasing spring (not shown). This allows the two support frames 37 and 38 to pivot about the axis of the pivot rod 374, varying the angle of the backrest relative to the seat. When the upper horizontal rods 371 and 381 are allowed to move apart, the biasing spring causes the ends of the lower horizontal rod 382 of the rear support frame 38 to reengage in the same or a different pair of notches 361 on the pivot mountings 36 to secure the backrest at the desired tilt angle.

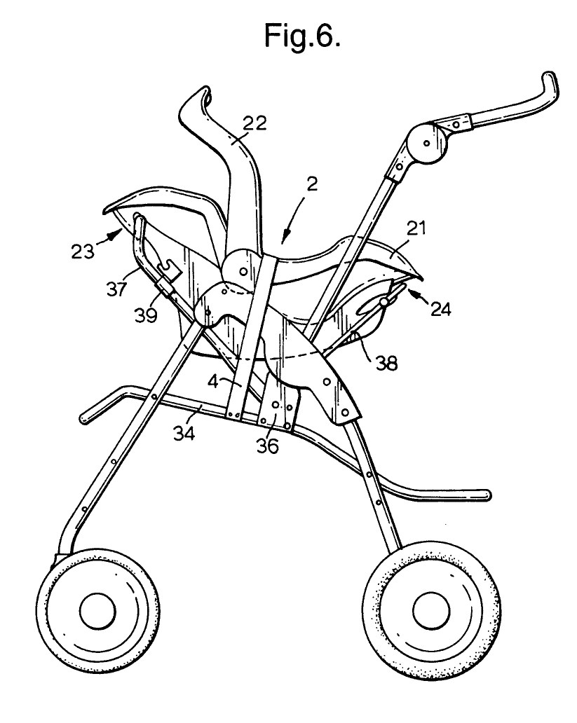

FIG. 6 shows with the car seat 2 mounted on the chassis 3. The catches 39 are disengaged from the vertical rods 383 and 384, allowing the front and rear support frames 37 and 38 to be extended into a V-shape, further extension being prevented by abutting formations on the pivot mountings 36. The distance between the upper horizontal rods 371 and 381 are the same as the distance between the retaining portions 23 and 24 on the car seat 2. This allows the pair of support frames 35 to provide support to the car seat 2. The lever latch 25 secures the car seat 2 in place.

Optionally, to provide additional security, after the car seat 2 is positioned, a webbing safety belt 4 may be fixed to a side of the chassis 3, run across the top of the car seat 2, and then be fastened to the other side of the framework 3.

1. A baby carriage chassis adapted to support a baby's car seat having front and rear retaining portions, the chassis comprising:
a main frame, and
a pair of support frames pivotally connected to the main frame for angular movement between a first position in which the support frames are substantially coplanar with one another to provide support for a baby's back when used without a car seat, and a second position in which the pair of support frames are extended into a V-shape to accommodate and support the front and rear retaining portions on the baby's car seat.

2. The chassis of claim 1, wherein the main frame comprises front legs, back legs, a handle, a set of wheels, a seat support member, and a pivot mounting.

3. The chassis of claim 2, wherein the pivot mounting is fastened to the seat support member.

4. The chassis of claim 3, wherein the pivot mounting is adjustable to various tilting positions.

5. The chassis of claim 1, wherein the front and back support frames each include two vertical rods and a horizontal rod to support the retaining portions of the baby's car seat.

6. The chassis of claim 5, wherein each of the two vertical rods of the front support frame contains a slot and the back support frame includes a lower horizontal rod that passes through the slots in the front support frame to extend into detent formations on the main frame.

7. The chassis of claim 6, wherein each of the two vertical rods of the front support frame has a catch for retaining the front and back support frames in their first position.

8. The chassis of claim 5, wherein each of the two vertical rods of the front support frame has a catch for retaining the front and back support frames in their first position.

9. A baby carriage chassis in combination with a baby's car seat having front and rear retaining portions, the chassis comprising:
a main frame, and
a pair of support frames pivotally connected to the main frame for angular movement between a first position in which the support frames are substantially coplanar with one another to provide support for a baby's back when used without a car seat, and a second position in which the pair of support frames are extended into a V-shape to accommodate and support the front and rear retaining portions on the car seat.

10. The combination of claim 9, further comprising a latch on car seat adapted to engage with one of the support frames.

11. The combination of claim 9, wherein, the car seat is secured by a safety belt having an end fixed to the chassis.

13. The combination of claim 9, wherein the main frame comprises front legs, back legs, a handle, a set of wheels, a seat support member, and a pivot mounting.

14. The combination of claim 13, wherein the pivot mounting is fastened to the seat support member.

15. The combination of claim 14, wherein the pivot mounting is adjustable to various tilting positions.

16. The combination of claim 9, wherein the front and back support frames each include two vertical rods and a horizontal rod to support the retaining portions of the baby's car seat.

17. The combination of claim 16, wherein each of the two vertical rods of the front support frame contains a slot and the back support frame includes a lower horizontal rod that passes through the slots in the front support frame to extend into detent formations on the main frame.

18. The combination of claim 17, wherein each of the two vertical rods of the front support frame has a catch for retaining the front and back support frames in their first position.

19. The combination of claim 16, wherein each of the two vertical rods of the front support frame has a catch for retaining the front and back support frames in their first position.
